(19) United States
(12) Patent Application Publication
(10) Pub. No.: US 2023/0273840 A1
(43) Pub. Date: Aug. 31, 2023

(54) METHOD AND SYSTEM FOR AUTOMATIC INTEGRATION OF SOFTWARE PRODUCTS DEPLOYED ON A CONTAINER-BASED CLUSTER

(71) Applicant: HCL Technologies Italy S.p.A., Milan (IT)

(72) Inventors: Luca Lazzaro, Rome (IT); Francesco Brillante, Rome (IT); Stefania Benedetta Stasi, Rome (IT); Roberto Francesco Lenci, Rome (IT); Ciro Oliviero, Rome (IT); Elvira Zanin

(21) Appl. No.: 17/590,856

(22) Filed: Feb. 2, 2022

(51) Int. Cl. G06F 9/54; G06F 9/50

(52) U.S. Cl. CPC G06F 9/54; G06F 9/5072; G06N 20/00

(57) ABSTRACT

A method and system for integration of software products deployed on a container-based cluster is disclosed. In some embodiments, the method includes extracting configuration parameters associated with a plurality of software products available on the container-based cluster in a pre-defined format, based on Application Programming Interface (APIs) associated with the plurality of software products; generating integration nodes and events for the plurality of software products based on the configuration parameters; receiving an input to connect at least two nodes from the plurality of integration nodes for integrating corresponding software products; determining a similarity between the at least two nodes based on input parameters and output parameters of the two nodes; and providing a suggestion on possible connections for the corresponding software products based on the similarity between the at least two nodes.

### TECHNICAL FIELD

Generally, the invention relates to software integration. More specifically, the invention relates to method and system for integration of software products deployed on a container-based cluster.

### BACKGROUND

Typically, in software integration, various types of software sub-systems may be brought together to create a unified single system. Most common way to integrate software products’ functionalities may be a Representational State Transfer Application Programming Interface (REST API) or any other type of API (such as, Webhooks). Other solutions are based on shared file (Integration Service Component, such as files shared via Cloud), or message (for example, MQTT used for integration to home assistant). However, REST API are provider dependent. For example, if the API changes, the integration needs to be changed. Moreover, the REST API are code intensive, and a code-based integration is usually time consuming. Further, file sharing solutions relay on standardized format of data, complicated for the user (especially if the user is inexperienced person).

Nowadays various software is available to resolve software integration like Business Process Management (BPM) or Workload Automation (WA). Nevertheless, they need to know which third-party software integration they allow. Therefore, there is a need to develop a system and method that may provide an alternative to integrate software of different domain using a simple way without requiring programming skills.

### SUMMARY OF INVENTION

In one embodiment, a method for integration of software products deployed on a container-based cluster is disclosed. The method may include extracting configuration parameters associated with a plurality of software products available on the container-based cluster in a pre-defined format, based on Application Programming Interface (APIs) associated with the plurality of software products. An API descriptor of an API may be parsed to identify a route to be called for a software product while extracting configuration the parameters. The method may further include generating integration nodes and events for the plurality of software products based on the configuration parameters. It should be noted that each of the plurality of software products may include a set of nodes and a set of events. Further, each of the set of nodes may include input parameters and output parameters. Also, it should be noted that each of the set of nodes may be assigned with a tag that may represent a type for that node. The method may further include receiving an input to connect at least two nodes from the plurality of integration nodes for integrating corresponding software products. The method may further include determining a similarity between the at least two nodes based on input and output parameters of the two nodes. The method may further include providing a suggestion on possible connections for the corresponding software products based on the similarity between the at least two nodes.

In another embodiment, a system for integration of software products deployed on a container-based cluster is disclosed. The system may include a processor and a memory communicatively coupled to the processor. The memory may store processor-executable instructions, which, on execution, may cause the processor to extract configuration parameters associated with a plurality of software products available on the container-based cluster in a pre-defined format, based on Application Programming Interface (APIs) associated with the plurality of software products. An API descriptor of an API may be parsed to identify a route to be called for a software product while extracting the configuration parameters. The processor-executable instructions, on execution, may further cause the processor to generate integration nodes and events for the plurality of software products based on the configuration parameters. It should be noted that each of the plurality of software products may include a set of nodes and a set of events. Further, each of the set of nodes may include input parameters and output parameters. Also, it should be noted that each of the set of nodes may be assigned with a tag that represents a type for that node. The processor-executable instructions, on execution, may further cause the processor to receive an input to connect at least two nodes from the plurality of integration nodes for integrating corresponding software products. The processor-executable instructions, on execution, may further cause the processor to determine a similarity between the at least two nodes based on input parameters and output parameters of the two nodes. The processor-executable instructions, on execution, may further cause the processor to provide a suggestion on possible connections for the corresponding software products based on the similarity between the at least two nodes.

In yet another embodiment, a non-transitory computer-readable medium storing computer-executable instruction for integration of software products deployed on a container-based cluster is disclosed. The stored instructions, when executed by a processor, may cause the processor to perform operations including extracting configuration parameters associated with a plurality of software products available on the container-based cluster in a pre-defined format, based on Application Programming Interface (APIs) associated with the plurality of software products. An API descriptor of an API may be parsed to identify a route to be called for a software product while extracting configuration the parameters. The operations may further include generating integration nodes and events for the plurality of software products based on the configuration parameters. It should be noted that each of the plurality of software products may include a set of nodes and a set of events. Further, each of the set of nodes may include input parameters and output parameters. Also, it should be noted that each of the set of nodes may be assigned with a tag that represents a type for that node. The operations may further include receiving an input to connect at least two nodes from the plurality of integration nodes for integrating corresponding software products. The operations may further include determining a similarity between the at least two nodes based on input and output parameters of the two nodes. The operations may further include providing a suggestion on possible connections for the corresponding software products based on the similarity between the at least two nodes.

It is to be understood that both the foregoing general description and the following detailed description are exemplary and explanatory only and are not restrictive of the invention, as claimed.

### BRIEF DESCRIPTION OF THE DRAWINGS

The present application can be best understood by reference to the following description taken in conjunction with the accompanying drawing figures, in which like parts may be referred to by like numerals

FIG. 1 is a block diagram illustrating a system for integration of software products deployed on a container-based cluster, in accordance with an embodiment.

FIG. 2 is a flowchart of a method for integration of software products deployed on a container-based cluster.

FIG. 3 is a flowchart of a method for generating integration nodes and events for the software products, in accordance with an embodiment.

FIG. 4 is a flowchart of a method for connecting various nodes, in accordance with an embodiment.

FIG. 5 is a flowchart of a method for providing suggestions on possible connections for the software products, in accordance with an embodiment.

FIG. 6 is a block diagram of an exemplary computer system for implementing embodiments consistent with the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

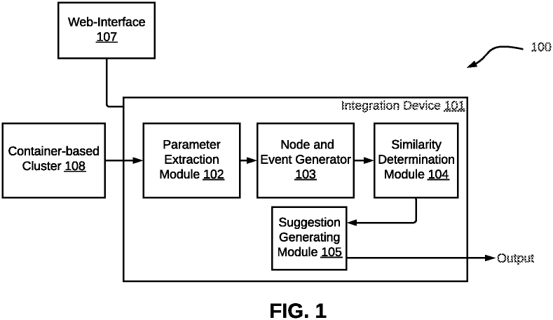

Referring now to FIG. 1, a block diagram of a system 100 for integration of software products deployed on a container-based cluster is illustrated, in accordance with an embodiment. The system 100 may include an integration device102 that may discover software products and services in an enterprise environment and automatically create a set of integration nodes, via web user interface 107. Therefore, the system 100 allows an easier integration between the software products. It should be noted that the integrated software products may be containerized and available on a container-based cluster (such as Kubernetes) 108. The integration device 101 may include a parameter extraction module 102, a node and event generator 103, a similarity determination module 104, and a suggestion generating module 105. Further, the integration device 101 may also include a data store to store various information and intermediate results generated by the modules 102-106.

The parameter extraction module 102 may be configured for extracting configuration parameters. The configuration parameters may be associated with a plurality of software products available on the container-based cluster 108. Further, the configuration parameters may be available in a pre-defined format. Further, the configuration parameters may be extracted based on Application Programming Interface (APIs) associated with the plurality of software products. It should be noted that an API descriptor of an API may be parsed to identify a route to be called for a software product while extracting configuration the parameters. Further, the parameter extraction module 102 may be communicatively connected to the node and event generator 103.

The node and event generator 103 may be configured for generating integration nodes and events for the plurality of software products. The integration nodes and events may be generated based on the configuration parameters extracted by the parameter extraction module 102. It should be noted that each of the plurality of software products may include a set of nodes and a set of events. Also, it should be noted that each of the set of nodes may include input parameters and output parameters. Further, each of the set of nodes may be assigned with a tag that may represent a type for that node. In some embodiments, an edge for each input parameter and for each output parameter may be created, for the integration nodes. Additionally, in some embodiments, validation rules for the input parameters and the output parameters may be generated and a template for a node may be selected based on the API descriptor. It should be noted that templates may be modified based on type of the API.

The similarity determination module 104 may be configured for determining similarity between at least two nodes based on input and output parameters of the two nodes. In some embodiments, an input to connect the at least two nodes from the plurality of integration nodes may be received in order to integrate corresponding software products. For determining the similarity, at least one of a mapping-techniques and a deep learning model may be used by the similarity determination module 104. Further, the similarity determination module 104 may be operatively coupled to the suggestion generating module 105.

The suggestion generating module 105 may be configured to provide a suggestion on possible connections for the corresponding software products. The suggestion may be provided based on the similarity between the at least two nodes. In one embodiment, based on the similarity, the at least two nodes may be connected directly when the input and output parameters of the at least two nodes are same. In another embodiment, the at least two nodes may be connected through a merging interface upon detection of a conflict while connecting nodes. It should be noted, for node connection, the at least two nodes should be similar and compatible nodes. The compatible nodes may be nodes that have similar input parameters and output parameters. Otherwise, the connection between the at least two nodes may be rejected when the at least two nodes are incompatible. Further, a notification upon detection of the conflict in node connection may be generated.

In some embodiments, the integration device 101 may learn a sequence. For example, the integration device 101 may learn a conflict type and associated solution, and node connections. The integration device 101 may use a Machine Learning (ML) Model for learning the sequence. In each integration cycle, the sequence may be stored in a database or a knowledge base for further integration cycles.

In short, the software products that may be integrated are containerized and available on a container-orchestrator cluster. Further, software products may expose the nodes, through a well-known REST route, and service discovers and configures them inside the web interface without the need of any user configuration. Further, the system 100 is capable of providing information related to the possibility to connect connectable software products. Based on that the web interface may provide suggestions.

The web interface 107 allows integration of nodes and events using building blocks. Each software product has a different palette of nodes and events, each one with input and output parameter that may be dragged and dropped in order to build a flow between functionalities of a single or multiple software products.

With regards to nodes and events, a node is an action, a service or a function exposed by the single software product that receives input parameters optionally and produces an output. An event may be raised by the software product to alert the integration platform that something happened at single product level. There may be two mechanisms used: a polling mechanism from the integration platform to the single product; and the integration platform exposes an API called by the single software product.

It should be noted that the system 100 and associated integration device 101 may be implemented in programmable hardware devices such as programmable gate arrays, programmable array logic, programmable logic devices, or the like. Alternatively, the system 100 and integration device 101 may be implemented in software for execution by various types of processors. An identified engine/module of executable code may, for instance, include one or more physical or logical blocks of computer instructions which may, for instance, be organized as an object, module, procedure, function, or other construct. Nevertheless, the executables of an identified engine/module need not be physically located together but may include disparate instructions stored in different locations which, when joined logically together, comprise the identified engine/module and achieve the stated purpose of the identified engine/module. Indeed, an engine or a module of executable code may be a single instruction, or many instructions, and may even be distributed over several different code segments, among different applications, and across several memory devices.

As will be appreciated by one skilled in the art, a variety of processes may be employed for integration of software products. For example, the exemplary system 100 and the integration device 101 may provide integration of software products deployed on a container-based cluster, by the process discussed herein. In particular, as will be appreciated by those of ordinary skill in the art, control logic and/or automated routines for performing the techniques and steps described herein may be implemented by the system 100 and the integration device 101 either by hardware, software, or combinations of hardware and software. For example, suitable code may be accessed and executed by the one or more processors on the integration device 101 to perform some or all of the techniques described herein. Similarly, application specific integrated circuits (ASICs) configured to perform some or all the processes described herein may be included in the one or more processors on the system 100.

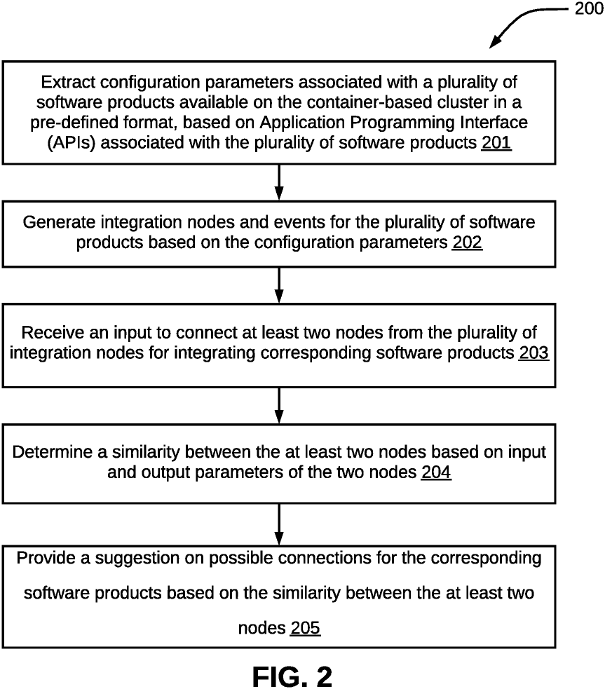

Referring now to FIG. 2, a method for integration of software products deployed on a container-based cluster is depicted via a flowchart 200, in accordance with an embodiment. Each step of the method may be executed by the modules 102-105 of the integration device 101. FIG. 2 is explained in conjunction with FIG. 1.

At step 201, configuration parameters may be extracted using the parameter extraction module 102. The configuration parameters may be associated with a plurality of software products available on the container-based cluster in a pre-defined format. Extraction may be performed based on Application Programming Interface (APIs) associated with the plurality of software products.

Further, at step 202, integration nodes and events for the plurality of software products may be generated based on the configuration parameters. The node and event generator 103 may be used to perform this step. It should be noted that each of the plurality of software products may include a set of nodes and a set of events. And, each of the set of nodes may include input parameters and output parameters. Further, each of the set of nodes may be assigned with a tag that represents a type for that node. In some embodiments, an edge for each input parameter and for each output parameter may be created, for the integration nodes. Further, in some embodiments, validation rules for the input parameters and the output parameters may be generated based on the API descriptor. Additionally, in some embodiments, a template may be selected for a node. Templates may be modified based on type of the API.

At step 203, an input may be received. The input may be received to connect at least two nodes from the plurality of integration nodes for integrating corresponding software products.

After that, at step 204, a similarity between the at least two nodes may be determined using the similarity determination module 104. The similarity determination may be based on input and output parameters of the two nodes. It should be noted that the similarity may be determined using at least one of mapping techniques, and a deep learning model.

At step 205, a suggestion on possible connections for the corresponding software products may be provided. The suggestion generating module 105 may be used to provide suggestions. The suggestion may be provided based on the similarity between the at least two nodes. In some embodiments, the at least two nodes may be connected directly when the input and output parameters of the at least two nodes are same based on the similarity. In some other embodiments, the at least two nodes may be connected through a merging interface upon detection of a conflict while connecting nodes. It should be noted that the at least two nodes may be compatible nodes. The compatible nodes may correspond to nodes that have similar input parameters and output parameters.

In some embodiments, the connection between the at least two nodes may be rejected when the at least two nodes are incompatible. And, a notification upon detection of the conflict in node connection may be generated. Further, in some embodiments, a Machine Learning (ML) Model may learn a sequence including conflict type and associated solution, and node connections which may be in a database for further integrations. The ML model may learn the sequence in each integration cycle.

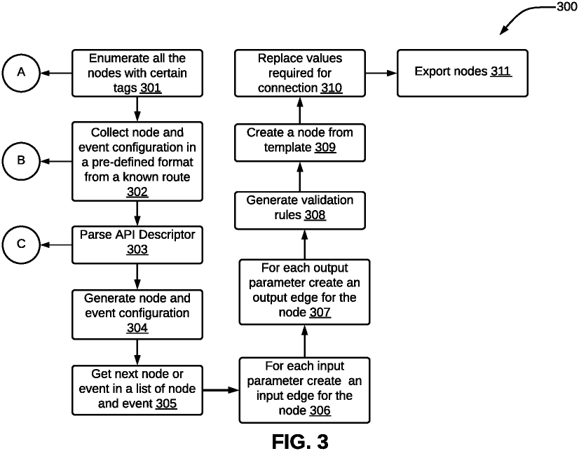

Referring now to FIG. 3, a method for generating integration nodes and events for the software products is depicted via a flowchart 300, in accordance with an embodiment. FIG. 3 is explained in conjunction with FIGS. 1-2. Steps 301-311 may be executed using the parameter extraction module 102, and the node and event generator 103.

At step 301, all the nodes may be enumerated with certain tags. Thereafter, at step 302, node and event configuration may be collected in a predefined format from a known route. In other words, configuration parameters associated with a plurality of software products may be extracted.

At step 303, an API descriptor of an API may be parsed to identify a route to be called for a software product while extracting configuration the parameters. Thereafter, at step 304, node and event configurations may be generated. At step 305, nodes and events may be collected in a list of nodes and events. It should be noted that each node includes input parameters and output parameters. At step 306, an input edge may be created for each input parameter of the node. Similarly, at step 307, an output edge may be created for each output parameter of the node.

Further, validation rules may be generated for the input parameters and the output parameters based on API descriptor, at step 308. After that, at step 309 and 310, a template for a node may be created, and required values may be replaced for connection. At step 311, the nodes may be extracted.

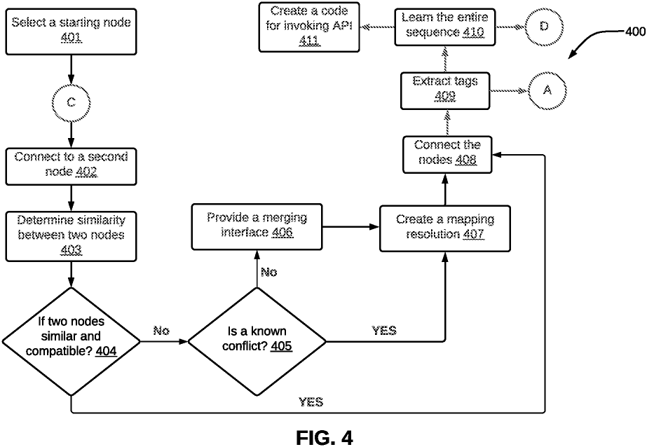

Referring now to FIG. 4, a method for connecting various nodes is depicted via a flowchart 400, in accordance with an embodiment. FIG. 4 is explained in conjunction with FIGS. 1-3. At step 401, a starting node may be selected. Thereafter, information associated with an API descriptor corresponding to the selected node may be collected. At step 402, the selected node may be connected to a second node. Further, at step 403, similarity between both the nodes may be determined.

Thereafter, at step 404, a condition, if both the nodes are similar and compatible, may be checked. In case the condition is false, step 405 may be executed. Otherwise, step 408 may be executed. At step 405, another condition that the conflict is already known or not, may be checked. In other words, if the conflict resolution is available or not may be checked. In case the conflict is new, step 407 may be executed after executing step 406. At step 406, a merging interface may be provided for conflict resolution. In case of available conflict resolution, step 407 may be executed directly.

At step 407, a mapping resolution may be created. Further, at step 408, the nodes may be connected. At step 409, tags may be extracted. At step 410, the entire sequence may be learnt by the ML model. At step 411, a code may be created for invoking API.

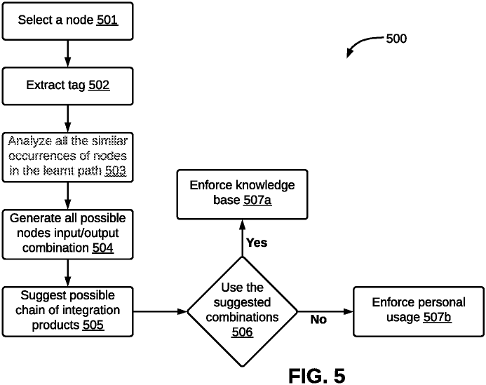

Referring now to FIG. 5, a method for providing suggestions on possible connections for the software products is depicted via a flowchart 500, in accordance with an embodiment. FIG. 5 is explained in conjunction with FIGS. 1-4. At step 501, a node may be selected. At step 502, a tag may be extracted from the node. At step 503, all the similar occurrences of nodes to the selected nodes may be analyzed in the learnt path. At step 504, all possible nodes input/output combinations may be generated. At step 505, a possible chain of integration software products may be suggested. Further, at step 506, a condition if the suggested combinations are used or not may be checked. If the condition is true, at step 507a, knowledge base may be enforced. Otherwise, at step 507b, personal usage may be enforced.

The process leverages tags extracted by the nodes based on the compatibility of the input and output of every node and a JSON line by line comparison in the JSON fields to establish how much they are similar. It should be noted that based on the connection already done by users (learned data from previous usage) the system 100 may provide a better flow re-organization to optimize the integration between nodes. The user may accept the suggestion or not. In both cases the preferences are stored for future usage.

By way of an example, consider a situation where an ACME corporation wants to improve daily access of their company website. In order to improve daily access, a marketing campaign may be defined to increase the audience of the website. In case of decreasing access rate ACME may want to schedule a campaign periodically. Therefore, three software products may be integrated with low code: one to periodically check the website access rate, second is to store the daily access to the website with a company owned application, and third is to third is to start the digital marketing campaign.

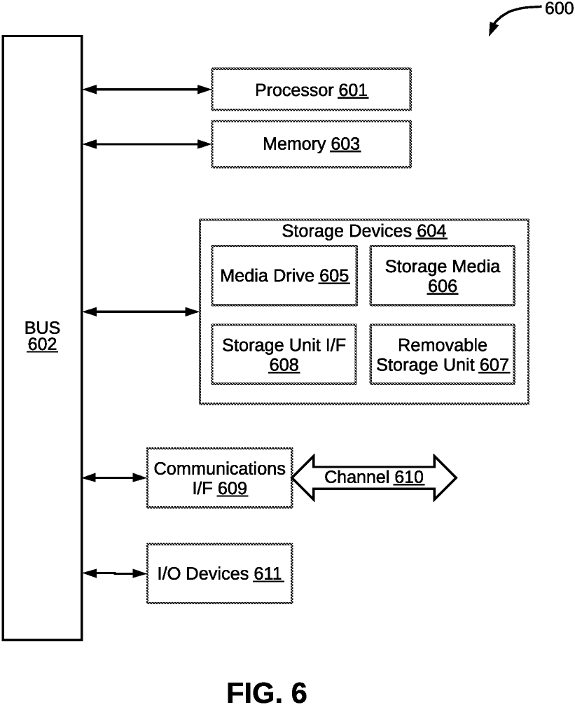

The disclosed methods and systems may be implemented on a conventional or a general-purpose computer system, such as a personal computer (PC) or server computer. Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 600 may represent, for example, a user device such as a desktop, a laptop, a mobile phone, personal entertainment device, DVR, and so on, or any other type of special or general-purpose computing device as may be desirable or appropriate for a given application or environment. The computing system 600 may include one or more processors, such as a processor 601 that may be implemented using a general or special purpose processing engine such as, for example, a microprocessor, microcontroller or other control logic. In this example, the processor 601 is connected to a bus 602 or other communication medium. In some embodiments, the processor 601 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 603 (main memory), for example, Random Access Memory (RAM) or other dynamic memory, for storing information and instructions to be executed by the processor 601. The memory 603 also may be used for storing temporary variables or other intermediate information during execution of instructions to be executed by the processor 601. The computing system 600 may likewise include a read only memory (“ROM”) or other static storage device coupled to bus 602 for storing static information and instructions for the processor 601.

The computing system 600 may also include a storage device 604, which may include, for example, a media drives 605 and a removable storage interface. The media drive 605 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 606 may include, for example, a hard disk, magnetic tape, flash drive, or other fixed or removable medium that is read by and written to by the media drive 605. As these examples illustrate, the storage media 606 may include a computer-readable storage medium having stored there in particular computer software or data.

In alternative embodiments, the storage devices 604 may include other similar instrumentalities for allowing computer programs or other instructions or data to be loaded into the computing system 600. Such instrumentalities may include, for example, a removable storage unit 607 and a storage unit interface 608, such as a program cartridge and cartridge interface, a removable memory (for example, a flash memory or other removable memory module) and memory slot, and other removable storage units and interfaces that allow software and data to be transferred from the removable storage unit 607 to the computing system 600.

The computing system 600 may also include a communications interface 609. The communications interface 609 may be used to allow software and data to be transferred between the computing system 600 and external devices. Examples of the communications interface 609 may include a network interface (such as an Ethernet or other NIC card), a communications port (such as for example, a USB port, a micro USB port), Near field Communication (NFC), etc. Software and data transferred via the communications interface 609 are in the form of signals which may be electronic, electromagnetic, optical, or other signals capable of being received by the communications interface 609. These signals are provided to the communications interface 609 via a channel 610. The channel 610 may carry signals and may be implemented using a wireless medium, wire or cable, fiber optics, or other communications medium. Some examples of the channel 610 may include a phone line, a cellular phone link, an RF link, a Bluetooth link, a network interface, a local or wide area network, and other communications channels.

The computing system 600 may further include Input/Output (I/O) devices 611. Examples may include, but are not limited to a display, keypad, microphone, audio speakers, vibrating motor, LED lights, etc. The I/O devices 611 may receive input from a user and also display an output of the computation performed by the processor 601. In this document, the terms “computer program product” and “computer-readable medium” may be used generally to refer to media such as, for example, the memory 603, the storage devices 604, the removable storage unit 607, or signal(s) on the channel 610. These and other forms of computer-readable media may be involved in providing one or more sequences of one or more instructions to the processor 601 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 607, the media drive 605 or the communications interface 609. The control logic (in this example, software instructions or computer program code), when executed by the processor 601, causes the processor 601 to perform the functions of the invention as described herein.

Various embodiments provide method and system for integration of software products deployed on a container-based cluster. The disclosed method and system may provide easy integration through a web user interface with an explicit palette of events and functionalities. Thereby, also allowing non-technical persons to build a cross-product flow. The integration is made through simple drag ‘n’ drop functionality between events and nodes. Moreover, no user configuration is needed to perform a full integration which is also a valuable aspect of the disclosure.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for integration of software products deployed on a container-based cluster, the method comprising:
extracting, by an integration device, configuration parameters associated with a plurality of software products available on the container-based cluster in a pre-defined format, based on Application Programming Interface (APIs) associated with the plurality of software products, wherein an API descriptor of an API is parsed to identify a route to be called for a software product while extracting configuration the parameters;
generating, by the integration device, integration nodes and events for the plurality of software products based on the configuration parameters, wherein each of the plurality of software products comprises a set of nodes and a set of events, and wherein each of the set of nodes comprises input parameters and output parameters, and wherein each of the set of nodes is assigned with a tag that represents a type for that node;
receiving, by the integration device, an input to connect at least two nodes from the plurality of integration nodes for integrating corresponding software products;
determining, by the integration device, a similarity between the at least two nodes based on input and output parameters of the two nodes; and
providing, by the integration device, a suggestion on possible connections for the corresponding software products based on the similarity between the at least two nodes.

2. The method of claim 1, wherein generating the plurality of integration nodes further comprises creating an edge for each input parameter and for each output parameter, for the integration nodes.

3. The method of claim 1, wherein generating the plurality of integration nodes further comprises:
based on the API descriptor:
generating validation rules for the input parameters and the output parameters; and
selecting a template for a node, wherein templates are modified based on a type of the API.

4. The method of claim 1, wherein providing the suggestions further comprises:
connecting the at least two nodes, based on the similarity, directly when the input and output parameters of the at least two nodes are same, or through a merging interface upon detection of a conflict while connecting nodes, wherein the at least two nodes are compatible nodes.

5. The method of claim 4, wherein the compatible nodes correspond to nodes that have similar input parameters and similar output parameters.

6. The method of claim 1, further comprising:
rejecting the connection between the at least two nodes when the at least two nodes are incompatible; and
generating a notification upon detection of the conflict in node connection.

7. The method of claim 1, wherein the similarity is determined using at least one of mapping techniques, and a deep learning model.

8. The method of claim 1, further comprising learning a sequence comprising a conflict type and associated solution, and node connections, using a Machine Learning (ML) Model, and storing the sequence in a database which is used for further integrations, in each integration cycle.

9. A system for integration of software products deployed on a container-based cluster, the system comprising:
a processor; and
a memory communicatively coupled to the processor, wherein the memory stores processor-executable instructions, which, on execution, causes the processor to:
extract configuration parameters associated with a plurality of software products available on the container-based cluster in a pre-defined format, based on Application Programming Interface (APIs) associated with the plurality of software products, wherein an API descriptor of an API is parsed to identify a route to be called for a software product while extracting the configuration parameters;
generate integration nodes and events for the plurality of software products based on the configuration parameters, wherein each of the plurality of software products comprises a set of nodes and a set of events, and wherein each of the set of nodes comprises input parameters and output parameters, and wherein each of the set of nodes is assigned with a tag that represents a type for that node;
receive an input to connect at least two nodes from the plurality of integration nodes for integrating corresponding software products;
determine a similarity between the at least two nodes based on input and output parameters of the two nodes; and
provide a suggestion on possible connections for the corresponding software products based on the similarity between the at least two nodes.

10. The system of claim 9, wherein the processor-executable instructions cause the processor to generate the plurality of integration nodes by creating an edge for each of the input parameters and the output parameters, for the integration nodes.

11. The system of claim 9, wherein the processor-executable instructions, based on the API descriptor, cause the processor to generate the plurality of integration nodes by:
generating validation rules for the input parameters and the output parameters; and
selecting a template for each node, wherein templates are modified based on type of the API.

12. The system of claim 9, wherein the processor-executable instructions cause the processor to provide the suggestions by connecting the at least two nodes, based on the similarity, directly when the input and output parameters of the at least two nodes are same or through a merging interface upon detection of a conflict while connecting nodes, wherein the at least two nodes are compatible nodes.

13. The system of claim 12, wherein the compatible nodes correspond to nodes that have similar input parameters and similar output parameters.

14. The system of claim 9, wherein the processor-executable instructions cause the processor to:
reject the connection between the at least two nodes when the at least two nodes are incompatible; and
generate a notification upon detection of the conflict in node connection.

15. The system of claim 9, wherein. the similarity is determined using at least one of mapping techniques, and a deep learning model.

16. The system of claim 9, wherein the processor-executable instructions further cause the processor to learn a sequence comprising a conflict type and associated solution, node connections, using a Machine Learning (ML) Model, and storing the sequence in a database which is used for further integrations, in each integration cycle.

17. A non-transitory computer-readable medium storing computer-executable instructions for integration of software products deployed on a container-based cluster, the computer-executable instructions configured for:
extracting configuration parameters associated with a plurality of software products available on the container-based cluster in a pre-defined format, based on Application Programming Interface (APIs) associated with the plurality of software products, wherein an API descriptor of an API is parsed to identify a route to be called for a software product while extracting configuration the parameters;
generating integration nodes and events for the plurality of software products based on the configuration parameters, wherein each of the plurality of software products comprises a set of nodes and a set of events, and wherein each of the set of nodes comprises input parameters and output parameters, and wherein each of the set of nodes is assigned with a tag that represents a type for that node;
receiving an input to connect at least two nodes from the plurality of integration nodes for integrating corresponding software products;
determining a similarity between the at least two nodes based on input and output parameters of the two nodes; and
providing a suggestion on possible connections for the corresponding software products based on the similarity between the at least two nodes.

18. The non-transitory computer-readable medium of claim 17, wherein the computer-executable instructions further configured for generating the plurality of integration nodes by creating an edge for each input parameter and for each output parameter, for the integration nodes.

19. The non-transitory computer-readable medium of claim 17, wherein the computer-executable instructions further configured for, based on the API descriptor, generating the plurality of integration nodes by:
generating validation rules for the input parameters and the output parameters; and
selecting a template for a node, wherein templates are modified based on a type of the API.

20. The non-transitory computer-readable medium of claim 17, wherein the computer-executable instructions further configured for connecting the at least two nodes, based on the similarity, directly when the input and output parameters of the at least two nodes are same, or through a merging interface upon detection of a conflict while connecting nodes, and wherein the at least two nodes are compatible nodes.
